(19) United States
(12) Patent Application Publication
(10) Pub. No.: US 2021/0394781 A1
(43) Pub. Date: Dec. 23, 2021

(54) DUAL LIDAR SENSOR FOR ANNOTATED POINT CLOUD GENERATION

(71) Applicant: Nuro, Inc., Mountain View, CA (US)

(72) Inventors: Hao Li, San Jose, CA (US); Russell Smith, Mountain View, CA (US)

(21) Appl. No.: 17/218,219

(22) Filed: Mar. 31, 2021

Related U.S. Application Data
(60) Provisional application No. 63/040,095, filed on Jun. 17, 2020.

(51) Int. Cl. B60W 60/00; G01S 17/894; G01S 17/58; G01S 17/42; G01S 7/48; G01S 17/931; B60W 30/09

(52) U.S. Cl. CPC B60W 60/001; G01S 17/894; G01S 17/58; B60W 2420/52; G01S 7/4808; G01S 17/931; B60W 30/09; G01S 17/42

(57) ABSTRACT

According to one aspect, a sensor system of an autonomous vehicle includes at least two lidar units or sensors. A first lidar unit, which may be a three-dimensional time of flight (ToF) lidar sensor, is arranged to obtain three-dimensional point data relating to a sensed object, and a second lidar unit, which may be a two-dimensional coherent or frequency modulated continuous wave (FMCW) lidar sensor, is arranged to obtain velocity data relating to the sensed object. The data from the first and second lidar units may be effectively correlated such that a point cloud may be generated that includes point data and annotated velocities.

### CROSS REFERENCE TO RELATED APPLICATION

This application claims priority to U.S. Provisional Patent Application No. 63/040,095, titled “Methods and Apparatus for Utilizing a Single Beam Digitally Modulated Lidar in an Autonomous Vehicle,” filed Jun. 17, 2020, the entirety of which is hereby incorporated herein by reference.

### TECHNICAL FIELD

The disclosure relates generally to sensor systems for autonomous vehicles.

### BACKGROUND

Light Detection and Ranging (lidar) is a technology that is often used in autonomous vehicles to measure distances to targets. Typically, a lidar system or sensor includes a light source and a target. The light source emits light towards a target that scatters the light. The detector receives some of the scattered light, and the lidar system determines a distance to the target based on characteristics associated with the received scattered light, or the returned light.

Lidar systems are typically used to generate three-dimensional point clouds of a surrounding environment that may include non-stationary obstacles, e.g., moving vehicles and/or moving pedestrians. While the point clouds are used to identify the location of obstacles, it is often inefficient and difficult to determine the velocity of non-stationary obstacles using the point clouds.

### BRIEF DESCRIPTION OF THE DRAWINGS

FIG. 1 is a diagram of an autonomous vehicle fleet in which a dual lidar sensor system to generate an annotated point cloud may be implemented, according to an example embodiment.

FIG. 2 is a diagram of a side of an autonomous vehicle in the dual lidar sensor system may be implemented, according to an example embodiment.

FIG. 3 is a block diagram of system components of an autonomous vehicle, according to an example embodiment.

FIG. 4A is a block diagram of a dual lidar sensor system, in accordance with an embodiment.

FIG. 4B is a functional diagram of the dual lidar sensor system, and illustrating connections between components, in accordance with an embodiment.

FIG. 5 is a diagrammatic representation of a system in which two different lidar sensors are used to provide a point cloud with annotated velocity information, in accordance with an embodiment.

FIG. 6 is a block diagram representation of a two-dimensional coherent or frequency modulated continuous wave (FMCW) lidar sensor that may be used in the dual lidar sensor system, in accordance with an embodiment.

FIG. 7A is a diagram depicting a field of view of a first lidar sensor that may be used in the dual lidar sensor system, according to an example embodiment.

FIG. 7B is a diagram depicting the field of view of a second lidar sensor that may be used in the dual lidar sensor system, according to an example embodiment.

FIG. 7C is a diagram depicting a single divergent beam that may be produced using the two-dimensional coherent or frequency modulated continuous wave (FMCW) lidar sensor depicted in FIG. 6, according to an example embodiment.

FIG. 8 is a process flow diagram depicting operations of the dual lidar sensor system, in accordance with an embodiment.

FIG. 9 is a diagram depicting operations for associating points generated by a two-dimensional lidar sensor with points generated by a three-dimensional lidar sensor in the dual lidar sensor system, according to an example embodiment.

FIG. 10 is a diagram depicting assignment of velocity information of points generated by a two-dimensional lidar sensor to corresponding points generated by a three-dimensional lidar sensor, according to an example embodiment.

FIG. 11 is a flow chart depicting, at a high-level, operations performed by the dual lidar sensor system, according to an example embodiment.

FIG. 12 is a block diagram of a computing device configured to perform functions associated with the techniques described herein, according to an example embodiment.

### DESCRIPTION OF EXAMPLE EMBODIMENTS

### Overview

In one embodiment, a sensor system of an autonomous vehicle includes at least two lidar units or sensors. A first lidar unit, which may be a three-dimensional Time-of-Flight (ToF) lidar sensor, is arranged to obtain three-dimensional point data relating to a sensed object, and a second lidar unit, which may be a two-dimensional coherent or frequency modulated continuous wave (FMCW) lidar sensor, is arranged to obtain velocity data relating to the sensed object. The data from the first and second lidar units may be effectively correlated such that a point cloud may be generated that includes point data and annotated velocity information.

### EXAMPLE EMBODIMENTS

As the number of autonomous vehicles on roadways is increasing, the ability for autonomous vehicles to operate safely is becoming more important. For example, the ability of sensors used in autonomous vehicles to accurately identify obstacles and to determine the velocity at which non-stationary obstacles are moving is critical. Further, the ability for an autonomous vehicle to continue operating until the autonomous vehicle may come to a safe stop in the event that a sensor fails also allows the autonomous vehicle to operate safely.

In one embodiment, a sensor system of an autonomous vehicle may include two or more lidar sensors that are arranged to cooperate to provide a point cloud with annotated velocity information, e.g., a point cloud that provides both dimensional point information and velocity information for objects. While a single, three-dimensional frequency modulated continuous wave (FMCW) lidar sensor may provide both dimensional information and velocity information relating to objects, three-dimensional FMCW lidar sensors are relatively expensive. Three-dimensional Time-of-Flight (ToF) lidar sensors provide dimensional information, e.g., three-dimensional point data, but do not efficiently provide velocity information. That is, a ToF lidar sensor may detect otherwise “see” objects, but are unable to determine velocities of the objects substantially in real-time. By utilizing a ToF lidar sensor to provide-dimensional information, and a two-dimensional FMCW lidar sensor to provide velocity information substantially in real-time, dimensional information and velocity information may be efficiently provided, e.g., a point cloud with annotated velocities may be generated. More generally, in a system that includes multiple lidar sensors, one lidar sensor may be used to obtain substantially standard information that may be used to generate a point cloud, while another lidar may be used primarily to obtain velocity information. The use of two or more lidar sensors, in addition to facilitating the collection of data such that a point cloud with annotated velocities may be generated, also provides redundancy such that if one lidar fails, another lidar may still be operational.

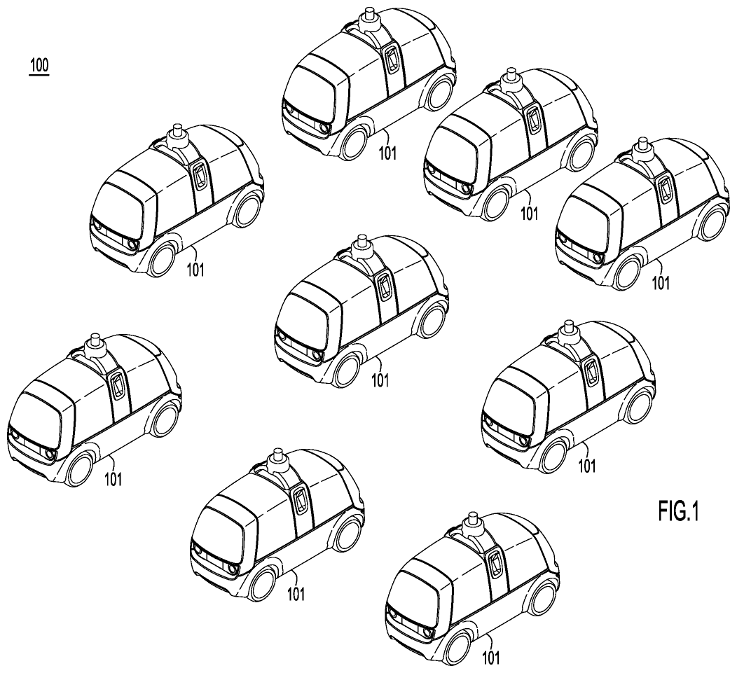

Referring initially to FIG. 1, an autonomous vehicle fleet will be described in accordance with an embodiment. An autonomous vehicle fleet 100 includes a plurality of autonomous vehicles 101, or robot vehicles. Autonomous vehicles 101 are generally arranged to transport and/or to deliver cargo, items, and/or goods. Autonomous vehicles 101 may be fully autonomous and/or semi-autonomous vehicles. In general, each autonomous vehicle 101 may be a vehicle that is capable of travelling in a controlled manner for a period of time without intervention, e.g., without human intervention. As will be discussed in more detail below, each autonomous vehicle 101 may include a power system, a propulsion or conveyance system, a navigation module, a control system or controller, a communications system, a processor, and a sensor system. Each autonomous vehicle 101 is a manned or unmanned mobile machine configured to transport people, cargo, or other items, whether on land or water, air, or another surface, such as a car, wagon, van, tricycle, truck, bus, trailer, train, tram, ship, boat, ferry, drove, hovercraft, aircraft, spaceship, etc.

Each autonomous vehicle 101 may be fully or partially autonomous such that the vehicle can travel in a controlled manner for a period of time without human intervention. For example, a vehicle may be “fully autonomous” if it is configured to be driven without any assistance from a human operator, whether within the vehicle or remote from the vehicle, while a vehicle may be “semi-autonomous” if it uses some level of human interaction in controlling the operation of the vehicle, whether through remote control by, or remote assistance from, a human operator, or local control/assistance within the vehicle by a human operator. A vehicle may be “non-autonomous” if it is driven by a human operator located within the vehicle. A “fully autonomous vehicle” may have no human occupant or it may have one or more human occupants that are not involved with the operation of the vehicle; they may simply be passengers in the vehicle.

In an example embodiment, each autonomous vehicle 101 may be configured to switch from a fully autonomous mode to a semi-autonomous mode, and vice versa. Each autonomous vehicle 101 also may be configured to switch between a non-autonomous mode and one or both of the fully autonomous mode and the semi-autonomous mode.

The fleet 100 may be generally arranged to achieve a common or collective objective. For example, the autonomous vehicles 101 may be generally arranged to transport and/or deliver people, cargo, and/or other items. A fleet management system (not shown) can, among other things, coordinate dispatching of the autonomous vehicles 101 for purposes of transporting, delivering, and/or retrieving goods and/or services. The fleet 100 can operate in an unstructured open environment or a closed environment.

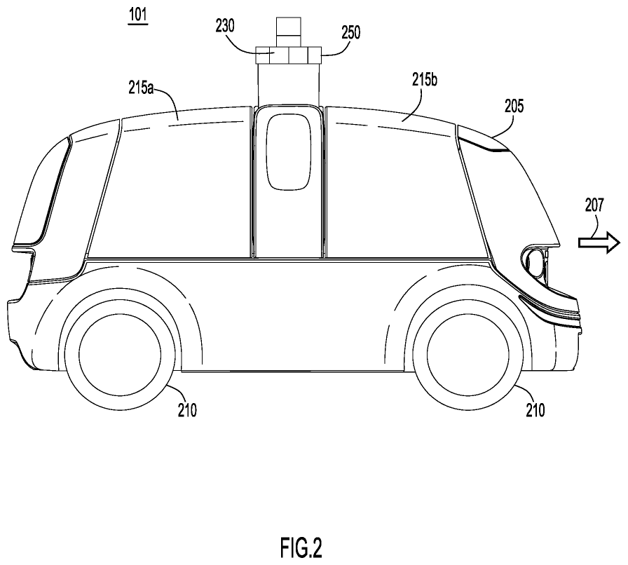

FIG. 2 is a diagram of a side of an autonomous vehicle 101, according to an example embodiment. The autonomous vehicle 101 includes a body 205 configured to be conveyed by wheels 210 and/or one or more other conveyance mechanisms. For example, the autonomous vehicle 101 can drive in a forward direction 207 and a reverse direction opposite the forward direction 207. In an example embodiment, the autonomous vehicle 101 may be relatively narrow (e.g., approximately two to approximately five feet wide), with a relatively low mass and low center of gravity for stability.

The autonomous vehicle 101 may be arranged to have a moderate working speed or velocity range of between approximately one and approximately forty-five miles per hour (“mph”), e.g., approximately twenty-five mph, to accommodate inner-city and residential driving speeds. In addition, the autonomous vehicle 101 may have a substantially maximum speed or velocity in a range of between approximately thirty and approximately ninety mph, which may accommodate, e.g., high speed, intrastate or interstate driving. As would be recognized by a person of ordinary skill in the art, the vehicle size, configuration, and speed/velocity ranges presented herein are illustrative and should not be construed as being limiting in any way.

The autonomous vehicle 101 includes multiple compartments (e.g., compartments 215a and 215b), which may be assignable to one or more entities, such as one or more customers, retailers, and/or vendors. The compartments are generally arranged to contain cargo and/or other items. In an example embodiment, one or more of the compartments may be secure compartments. The compartments 215a and 215b may have different capabilities, such as refrigeration, insulation, etc., as appropriate. It should be appreciated that the number, size, and configuration of the compartments may vary. For example, while two compartments (215a, 215b) are shown, the autonomous vehicle 101 may include more than two or less than two (e.g., zero or one) compartments.

The autonomous vehicle 101 further includes a sensor pod 230 that supports one or more sensors configured to view and/or monitor conditions on or around the autonomous vehicle 101. For example, the sensor pod 230 can include one or more cameras 250, light detection and ranging (“LiDAR”) sensors, radar, ultrasonic sensors, microphones, altimeters, or other mechanisms configured to capture images (e.g., still images and/or videos), sound, and/or other signals or information within an environment of the autonomous vehicle 101.

Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

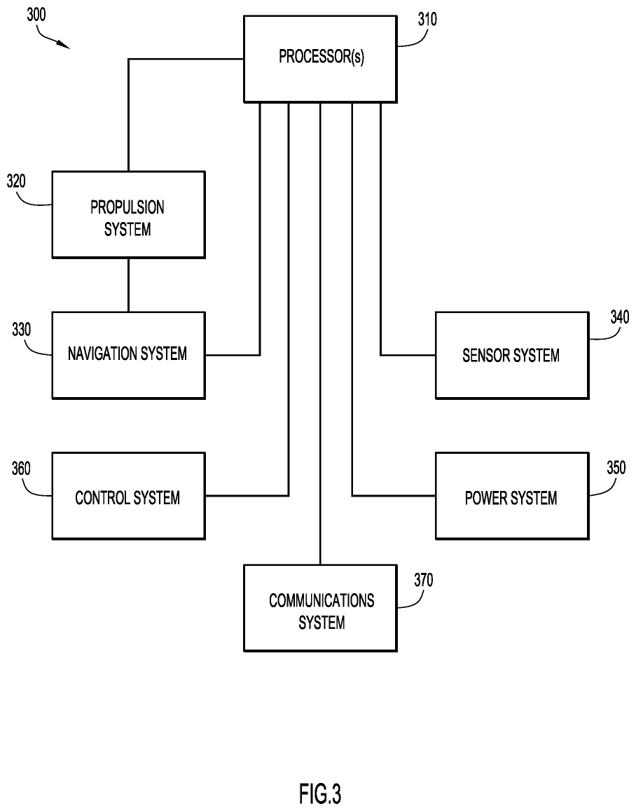

FIG. 3 is a block diagram representation of the system components 300 of an autonomous vehicle, e.g., autonomous vehicle 101 of FIG. 1, in accordance with an embodiment. The system components 300 of the autonomous vehicle 101 include a processor 310, a propulsion system 320, a navigation system 330, a sensor system 340, a power system 350, a control system 360, and a communications system 370. It should be appreciated that processor 310, propulsion system 320, navigation system 330, sensor system 340, power system 350, and communications system 370 are all coupled to a chassis or body of autonomous vehicle 101.

Processor 310 is arranged to send instructions to and to receive instructions from or for various components such as propulsion system 320, navigation system 330, sensor system 340, power system 350, and control system 360. Propulsion system 320, or a conveyance system, is arranged to cause autonomous vehicle 101 to move, e.g., drive. For example, when autonomous vehicle 101 is configured with a multi-wheeled automotive configuration as well as steering, braking systems and an engine, propulsion system 320 may be arranged to cause the engine, wheels, steering, and braking systems to cooperate to drive. In general, propulsion system 320 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine.

Navigation system 330 may control propulsion system 320 to navigate autonomous vehicle 101 through paths and/or within unstructured open or closed environments. Navigation system 330 may include at least one of digital maps, street view photographs, and a global positioning system (GPS) point. Maps, for example, may be utilized in cooperation with sensors included in sensor system 340 to allow navigation system 330 to cause autonomous vehicle 101 to navigate through an environment.

Sensor system 340 includes any sensors, as for example LiDAR, radar, ultrasonic sensors, microphones, altimeters, and/or cameras. Sensor system 340 generally includes onboard sensors that allow autonomous vehicle 101 to safely navigate, and to ascertain when there are objects near autonomous vehicle 101. In one embodiment, sensor system 340 may include propulsion systems sensors that monitor drive mechanism performance, drive train performance, and/or power system levels.

Sensor system 340 may include multiple lidars or lidar sensors. The use of multiple lidars in sensor system 340 provides redundancy such that if one lidar unit effectively becomes non-operational, there is at least one other lidar unit that may be operational or otherwise functioning. Multiple lidars included in sensor system 340 may include a three-dimensional TOF lidar system and a two-dimensional coherent or FMCW lidar sensor. In one form, the two-dimensional coherent of FMCW lidar sensor may utilize a single, substantially divergent beam which has an elevation component but is scanned substantially only in azimuth.

Power system 350 is arranged to provide power to autonomous vehicle 101. Power may be provided as electrical power, gas power, or any other suitable power, e.g., solar power or battery power. In one embodiment, power system 350 may include a main power source, and an auxiliary power source that may serve to power various components of autonomous vehicle 101 and/or to generally provide power to autonomous vehicle 101 when the main power source does not does not have the capacity to provide sufficient power.

Communications system 370 allows autonomous vehicle 101 to communicate, as for example, wirelessly, with a fleet management system (not shown) that allows autonomous vehicle 101 to be controlled remotely. Communications system 370 generally obtains or receives data, stores the data, and transmits or provides the data to a fleet management system and/or to autonomous vehicles 101 within a fleet 100. The data may include, but is not limited to including, information relating to scheduled requests or orders, information relating to on-demand requests or orders, and/or information relating to a need for autonomous vehicle 101 to reposition itself, e.g., in response to an anticipated demand.

In some embodiments, control system 360 may cooperate with processor 310 to determine where autonomous vehicle 101 may safely travel, and to determine the presence of objects in a vicinity around autonomous vehicle 101 based on data, e.g., results, from sensor system 340. In other words, control system 360 may cooperate with processor 310 to effectively determine what autonomous vehicle 101 may do within its immediate surroundings. Control system 360 in cooperation with processor 310 may essentially control power system 350 and navigation system 330 as part of driving or conveying autonomous vehicle 101. Additionally, control system 360 may cooperate with processor 310 and communications system 370 to provide data to or obtain data from other autonomous vehicles 101, a management server, a global positioning server (GPS), a personal computer, a teleoperations system, a smartphone, or any computing device via the communications system 370. In general, control system 360 may cooperate at least with processor 310, propulsion system 320, navigation system 330, sensor system 340, and power system 350 to allow vehicle 101 to operate autonomously. That is, autonomous vehicle 101 is able to operate autonomously through the use of an autonomy system that effectively includes, at least in part, functionality provided by propulsion system 320, navigation system 330, sensor system 340, power system 350, and control system 360.

As described above, when autonomous vehicle 101 operates autonomously, vehicle 101 may generally operate, e.g., drive, under the control of an autonomy system. That is, when autonomous vehicle 101 is in an autonomous mode, autonomous vehicle 101 is able to generally operate without a driver or a remote operator controlling autonomous vehicle. In one embodiment, autonomous vehicle 101 may operate in a semi-autonomous mode or a fully autonomous mode. When autonomous vehicle 101 operates in a semi-autonomous mode, autonomous vehicle 101 may operate autonomously at times and may operate under the control of a driver or a remote operator at other times. When autonomous vehicle 101 operates in a fully autonomous mode, autonomous vehicle 101 typically operates substantially only under the control of an autonomy system. The ability of an autonomous system to collect information and extract relevant knowledge from the environment provides autonomous vehicle 101 with perception capabilities. For example, data or information obtained from sensor system 340 may be processed such that the environment around autonomous vehicle 101 may effectively be perceived.

As previously mentioned, the ability to efficiently generate a point cloud that includes velocity information, in addition to three-dimensional point (location) data, may be provided using two or more lidar sensors/lidar units. One lidar sensor/unit may be a ToF lidar sensor, and another lidar sensor/unit may be a two-dimensional coherent or FMCW lidar sensor. Once generated, the point cloud that includes velocity information may be used by an overall autonomy system, e.g., by a perception system included in or associated with the autonomy system, to facilitate the driving or propulsion of an autonomous vehicle.

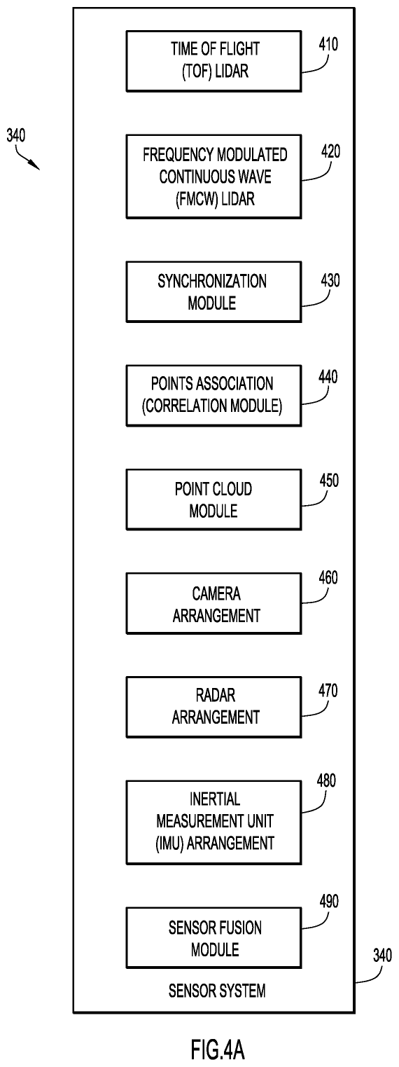

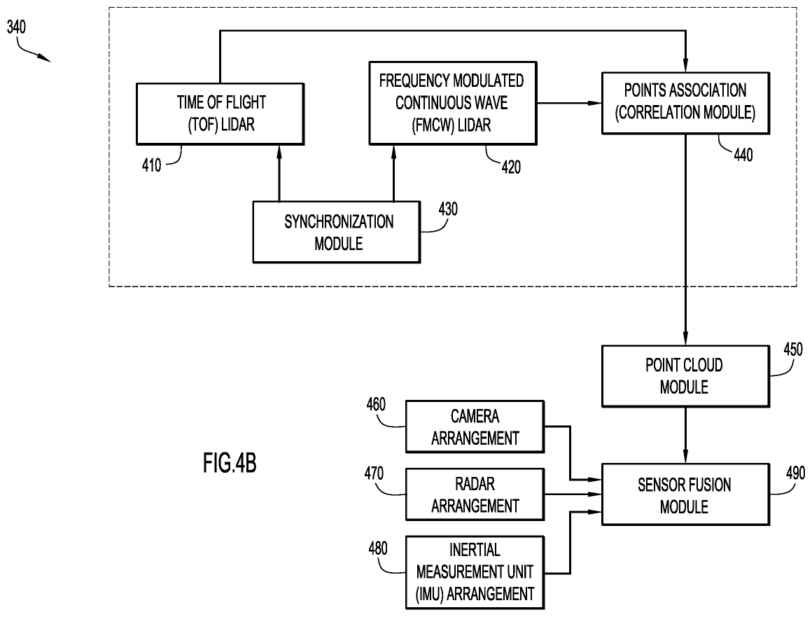

With reference to FIGS. 4A and 4B, an overall sensor system that includes dual lidar sensors (a two-dimensional coherent or FMCW lidar sensor and a ToF lidar sensor) will be described in accordance with an embodiment. FIG. 4A is a block diagram representation of a sensor system, e.g., sensor system 340 of FIG. 3, in accordance with an embodiment. Sensor system 340 includes a ToF lidar sensor 410, and a coherent or FMCW lidar sensor 420. ToF lidar sensor 410 is generally a three-dimensional lidar sensor. In the described embodiment, coherent or FMCW lidar sensor 420 may be a two-dimensional lidar sensor that is arranged to obtain at least velocity information relating to detected objects. It should be appreciated, however, that two-dimensional coherent or FMCW lidar sensor 420 may generally be any coherent or FMCW lidar sensor that is capable of efficiently obtaining velocity information relating to detected objects.

Sensor system 340 also includes a synchronization module 430, a points association or correlation module 440, and a point cloud module 450. Synchronization module 430 is configured to synchronize data or information obtained, e.g., sensed, by ToF lidar sensor 410 and coherent or FMCW lidar sensor 420. Synchronizing data generally involves synchronizing times at which data are obtained such that data collected at a time t1 may be substantially matched together. That is, synchronizing data generally includes matching data obtained using ToF lidar sensor 410 with data obtained using coherent or FMCW lidar sensor 420. In one embodiment, synchronization module 430 achieves pixel-level synchronization between ToF lidar sensor 410 and coherent of FMCW lidar sensor 420 through motor-phase locking. Motor-phase locking is a technique that may be used to ensure that the ToF lidar sensor 410 and the coherent of FMCW lidar sensor 420 are always facing the same direction at the same time, and thus have the same FOV. This makes associating the data between the two lidar sensors much easier and accurate. An alternative to motor-phase locking is to mount the ToF lidar sensor 410 and the two-dimensional coherent or FMCW lidar sensor 420 onto a single motor platform so that they are always synchronized (scanning essentially the same FOV at the same time).

Points association or correlation module 440 is configured to assign associations between point data obtained by the ToF lidar sensor 410 and point data obtained by the coherent or FMCW lidar sensor 420 based on, but not limited to, temporal, spatial, and intensity correlations. In one embodiment, coherent or FMCW lidar sensor 420 may provide a two-dimensional scan in a substantially vertical direction, e.g., a line. Data, such as measurements along the same direction, obtained by ToF lidar sensor 410, may be associated with data obtained from a two-dimensional scan by coherent or FMCW lidar sensor 420. In general, points association or correlation module 440 associates data obtained by ToF lidar sensor 410 and coherent or FMCW lidar sensor 420 with one or more objects seen by both lidar sensors.

Point cloud module 450 creates a three-dimensional point cloud from data obtained by ToF lidar sensor 410 and coherent or FMCW lidar sensor 420. The three-dimensional point cloud includes annotated velocity information. In one embodiment, velocity information obtained using coherent or FMCW lidar sensor 420 may be assigned to the point cloud created using information collected by ToF lidar sensor 410 based on range (spatial/location) and reflectivity intensity correspondence. In general, objects that are relatively close together, and have a similar range and substantially the same reflectivity intensity, may be treated as a single object with respect to the point cloud.

Sensor system 340 also includes a variety of other sensors that facilitate the operation of an autonomous vehicle, e.g., autonomous vehicle 101 of FIGS. 2 and 3. Such other sensors may include, but are not limited to, a camera arrangement 460, a radar arrangement 470, and an inertial measurement unit (IMU) arrangement 480. Camera arrangement 460 may generally include one or more cameras such as a high definition (HD) camera. Radar arrangement 470 may include any number of radar units, and may include a millimeter wave (mmWave) radar unit, IMU arrangement 480 is generally arranged to measure or to otherwise determine forces, orientations, and rates. In one embodiment, IMU arrangement 480 may include one or more accelerometers and/or gyroscopic devices.

A sensor fusion module 490 that is part of sensor system 340 is configured to amalgamate information obtained from ToF lidar sensor 410, coherent or FMCW lidar sensor 420, camera arrangement 460, radar arrangement 470, and IMU arrangement 480 such that an image of an overall environment may be substantially created. That is, sensor fusion module 490 creates a model of the overall environment around a vehicle, e.g., autonomous vehicle 101, using data or measurements obtained by ToF lidar sensor 410, coherent or FMCW lidar sensor 420, camera arrangement 460, radar arrangement 470, and IMU arrangement 480. The image or model created by sensor fusion module 490 be used by an autonomy system, as for example by a perception system included in, or otherwise associated with, the autonomy system. The result is that movement of the autonomous vehicle 101 may be controlled based, at least in part, on location and velocity of one or more objects detected in the field of view of the two lidar sensors.

FIG. 4B is a functional diagrammatic representation of sensor system 340, showing functional connections between components in accordance with an embodiment. Within sensor system 340, synchronization module 430 synchronizes data or information collected by ToF lidar sensor 410 and two-dimensional coherent or FMCW lidar sensor 420. The synchronized data is then provided to points association or correlation module 440, which then associates the synchronized data with one or more objects.

The output of points association or correlation module 440 is provided to point cloud module 450 that creates a point cloud with annotated velocities. Point cloud module 450 then feeds data into sensor fusion module 490, which also obtains data from camera arrangement 460, radar arrangement 470, and IMU arrangement 480. Sensor fusion module 490 then effectively creates an overall image of an environment based upon the data obtained.

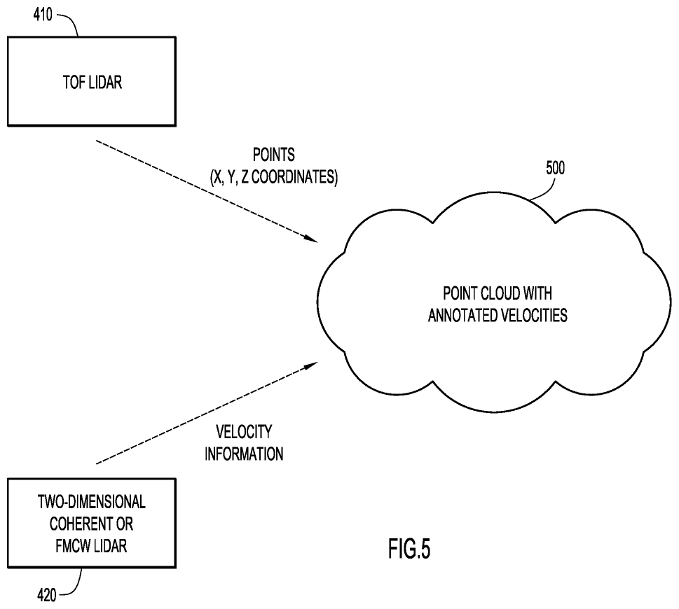

FIG. 5 is a diagrammatic representation of a system in which two different lidar sensors are used to provide a point cloud with annotated velocities in accordance with an embodiment. ToF lidar sensor 410 may collect dimensional data or points relating to sensed objects that may be used to generate a point cloud. This dimensional data is referred to herein as first point data. Coherent or FMCW lidar sensor 420, e.g., a two-dimensional coherent or FMCW lidar sensor, may collect two-dimensional location and velocity information relating to sensed objects, referred to herein as second point data.

ToF lidar sensor 410 provides points relating to sensed objects, as for example in x, y, z coordinates, to a point cloud 500. Coherent or FMCW lidar sensor 420 provides two-dimensional location information and velocity information relating to sensed objects to point cloud 500. As a result, point cloud 500 includes points (each representing a detected object) with annotated velocities.

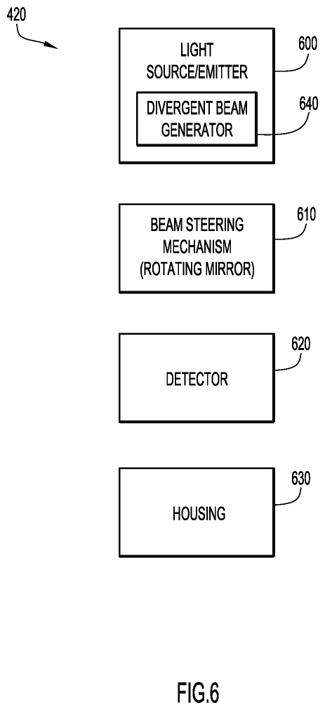

As mentioned above, a two-dimensional coherent or FMCW lidar sensor is typically arranged to scan substantially only in azimuth, and not in elevation. FIG. 6 is a block diagram representation of two-dimensional coherent or FMCW lidar sensor 420 which allows a beam to be scanned substantially only in azimuth, in accordance with an embodiment. Two-dimensional coherent or FMCW lidar sensor 420 includes a light source or emitter 600, a beam steering mechanism 610, a detector 620, and a housing 630. As will be appreciated by those skilled in the art, two-dimensional coherent lidar sensor 420 may include many other components e.g., lenses such as a receiving lens. Such various other components have not been shown for ease of illustration.

Light source 600 may generally emit a light at any suitable wavelength, e.g., a wavelength of approximately 1550 nanometers. It should be appreciated that a wavelength of approximately 1550 nanometers may be preferred for reasons including, but not limited to including, eye safety power limits. In general, suitable wavelengths may vary widely and may be selected based upon factors including, but not limited to including, the requirements of an autonomous vehicle which includes two-dimensional coherent or FMCW lidar sensor 420 and/or the amount of power available to two-dimensional coherent or FMCW lidar sensor 420.

Light source 600 may include a divergent beam generator 640. In one embodiment, divergent beam generator 640 may create a single divergent beam, and light source 600 may be substantially rigidly attached to a surface, e.g., a surface of an autonomous vehicle, through housing 630. In other words, light source 600 may be arranged not to rotate.

Beam steering mechanism 610 is arranged to steer a beam generated by divergent beam generator 640. In one embodiment, beam steering mechanism 610 may include a rotating mirror that steers a beam substantially only in azimuth, e.g., approximately 360 degrees in azimuth. Beam steering mechanism may be arranged to rotate clockwise and/or counterclockwise. The rotational speed of beam steering mechanism 610 may vary widely. The rotating speed may be determined by various parameters including, but not limited to including, a rate of detection, and/or field of view.

Detector 620 is arranged to receive light after light emitted by light source 600 is reflected back to two-dimensional coherent or FMCW lidar sensor 420. Housing 630 is generally arranged to contain light source 600, beam steering mechanism 610, and detector 620.

Further details of features and functions that may be employed by coherent/FMCW lidar sensor 420 are disclosed in commonly assigned and co-pending U.S. patent application Ser. No. 16/998,294, filed Aug. 20, 2020, entitled “Single Beam Digitally Modulated Lidar for Autonomous Vehicle Sensing,” the entirety of which is incorporated herein by reference.

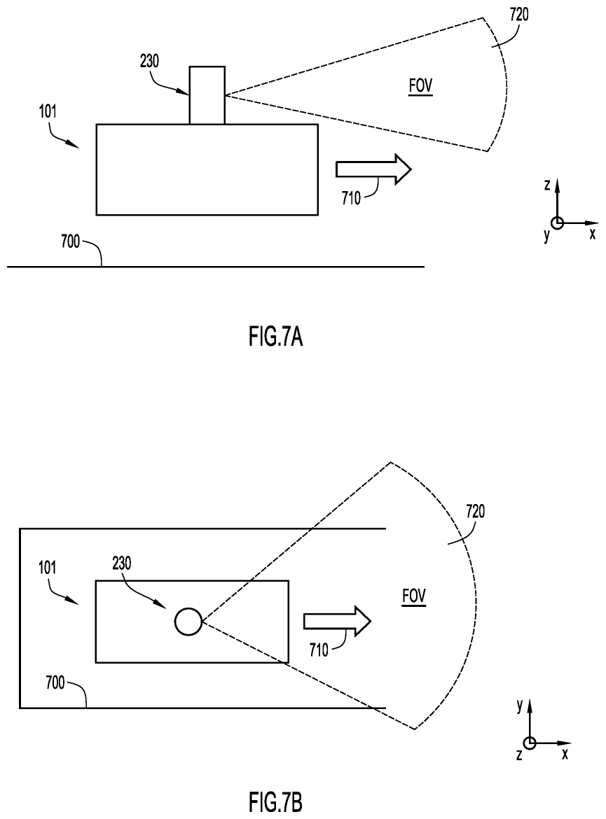

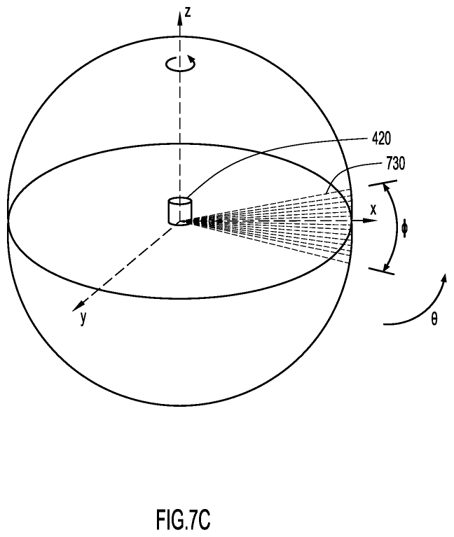

Reference is now made to FIGS. 7A and 7B. FIG. 7A generally shows the operational field of view (FOV) of the ToF lidar sensor 410, and FIG. 7B generally shows the operational FOV of the coherent/FMCW lidar sensor 420. For simplicity, it is understood that the ToF lidar sensor 410 and the coherent/FMCW lidar sensor 420 are co-located within sensor pod 230 shown on top of autonomous vehicle 101 in FIGS. 7A and 7B, and autonomous vehicle 101 is moving along a road 700 in direction 710. The ToF lidar sensor 410 and the coherent/FMCW lidar sensor 420 have the same field of view (FOV) 720.

FIG. 7A generally shows the operation of ToF lidar sensor 410, and this figure depicts a side view of the autonomous vehicle 10 traveling in direction 710. ToF lidar sensor 410 emits or transmits a laser beam, e.g., a laser pulse that may reflect off one or more objects. The ToF lidar sensor 410 collects the reflected beam, and determines a distance between the sensor and the object based on a difference between a time of transmission of the beam and a time of arrival of the reflected beam. FIG. 7A shows the FOV 720 as seen by the ToF lidar sensor 410 may span a three-dimensional volume of space at a distance from the direction 710 of movement of the autonomous vehicle 101. In general, a ToF lidar sensor may be used to identify the existence of an object and a location of the object, but generally may not be used to efficiently determine a velocity of movement of the object.

Turning now to FIG. 7B, the general operation of the two-dimensional coherent or FMCW lidar sensor 420 is shown. This figure depicts a top view of the autonomous vehicle 10 traveling in direction 710. A two-dimensional coherent or FMCW lidar sensor 420 may scan a single divergent, or fan-shaped, laser beam substantially only in azimuth (y-direction in FIGS. 7A and 7B) and not in elevation (z-direction in FIGS. 7A and 7B). Thus, the FOV 720 as seen by the two-dimensional coherent or FMCW lidar sensor 420 may be two-dimensional within the x-y plan as shown in FIG. 2B. A coherent or FMCW lidar sensor 420 may transmit a continuous beam with a predetermined, continuous change in frequency, and may collect the reflected beam. Using information relating to the continuous beam and the reflected beam, distance measurements and velocity measurements of objects off which the beam reflects may be obtained. In one embodiment, as a two-dimensional coherent or FMCW lidar sensor may not provide sufficient or highly-accurate information relating to a location of an object, the two-dimensional coherent or FMCW lidar sensor 420 may be used primarily to obtain velocity information relating to the object. Such velocity information may include directional velocity information, e.g., may include information which indicates a general direction in which an object is moving.

It is understood that the ToF lidar sensor 410 and the two-dimensional coherent or FMCW lidar sensor 420 are configured to generate data related to objects of substantially the same FOV. For example, the ToF lidar sensor 410 can produce a three-dimensional point location of object locations and the two-dimensional coherent or FMCW lidar sensor 420 can produce information in a two-dimensional space that is essentially a subset of the three-dimensional space viewed by the ToF lidar sensor 410 such that the ToF lidar sensor 410 and two-dimensional coherent or FMCW lidar sensor 420 are “seeing” the same objects at substantially the same instants of time.

As will be appreciated by those skilled in the art, data collected from a ToF lidar sensor may be used to estimate a velocity of the object by processing multiple frames over a predetermined amount of time. However, such an estimation of velocity is time-consuming and often leads to increased latency due to the need to process multiple frames.

FIG. 7C is a diagrammatic representation of a single divergent beam 730 that the coherent or FMCW lidar sensor 420 may produce. The single divergent beam 730 has a component in elevation and is scanned substantially only in azimuth (angle θ) in accordance with an embodiment. Coherent or FMCW lidar sensor 420 may be arranged to produce a single divergent beam 730 that is scanned about a z-axis. Beam 730 may be substantially fan-shaped, and have an elevation component. In one embodiment, the elevation component of beam 730 is an angle ϕ that is in a range of between approximately −10 degrees and approximately 10 degrees. Beam 730 may have any suitable operating wavelength, e.g., an operating wavelength of approximately 1550 nanometers.

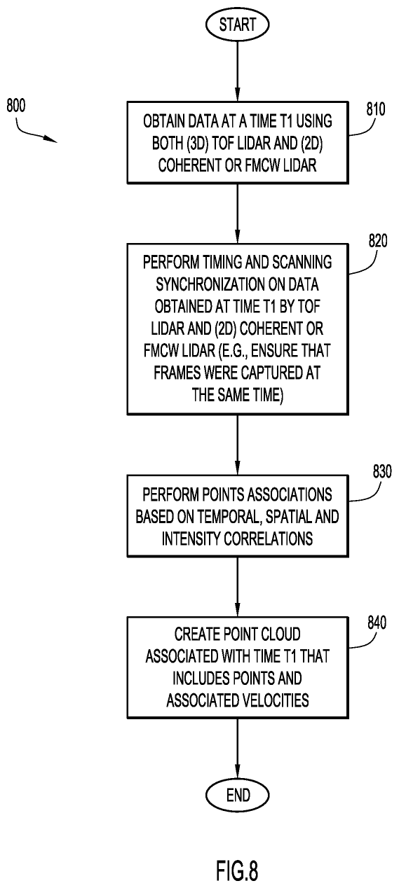

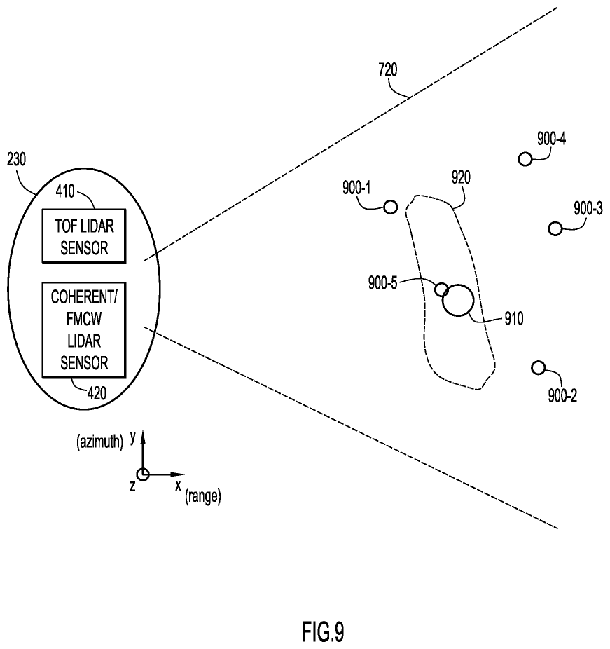

Referring next to FIG. 8, a process flow diagram is shown depicting a method 800 of utilizing an overall sensor system that includes two different lidar sensors, in accordance with an embodiment. The method 800 of utilizing an overall sensor system which includes a ToF lidar sensor and a coherent or FMCW lidar sensor begins at a step 810 in which data (point data) is obtained at a time T1 using both a ToF lidar sensor and a coherent or FMCW lidar sensor. That is, point data is collected by both a ToF lidar sensor and a coherent or FMCW lidar sensor that are part of a sensor system of an autonomous vehicle. The ToF lidar sensor generally obtains three-dimensional point data relating to an object, while the coherent or FMCW lidar sensor obtains two-dimensional point data and velocity information relating to the object. The ToF lidar sensor and the coherent or FMCW lidar sensor may have the substantially the same scanning pattern/field of view so that they are detecting the same objects at the same time. This allows for alignment of captured data in a manner that can be achieved more easily and more accurately, than could otherwise be achieved with a lidar sensor and a camera, or with a lidar sensor and a radar sensor.

In a step 820, timing and scanning synchronization is performed on the data obtained at time T1 by the ToF lidar sensor and by the coherent or FMCW lidar sensor. This involves aligning data from the two lidar sensors captured at the same instant of time. The timing and synchronization may be performed on three-dimensional point data obtained by the ToF lidar sensor and on two-dimensional location data and velocity data obtained by the coherent or FMCW lidar sensor. The timing and scanning synchronization, which may involve motor-phase locking, generally achieves a pixel-level synchronization between the ToF lidar sensor and the coherent or FMCW lidar sensor. By performing timing and scanning synchronization, frames associated with each lidar sensor may be substantially matched up based on timing.

After timing and scanning synchronization is performed, process flow moves to a step 830 in which points associations are performed based on temporal, spatial, and reflectivity intensity correlations. Points associations may involve, but are not limited to involving, assigning velocity information to three-dimensional point data based on range and reflectivity intensity correspondence. This timing and scanning synchronization step assists in the confidence of assignment of the velocity information obtained by the coherent or FMCW lidar sensor to points detected by TOF lidar sensor. The same objects should be detected by the two lidar sensors at the same range and with generally the same reflectivity/intensity, and detected at the same time. An example of this point association step is described below in connection with FIG. 9.

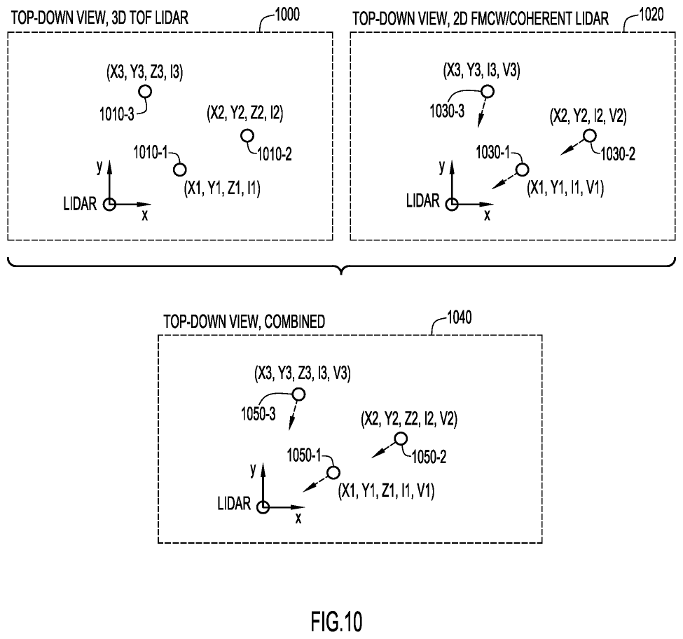

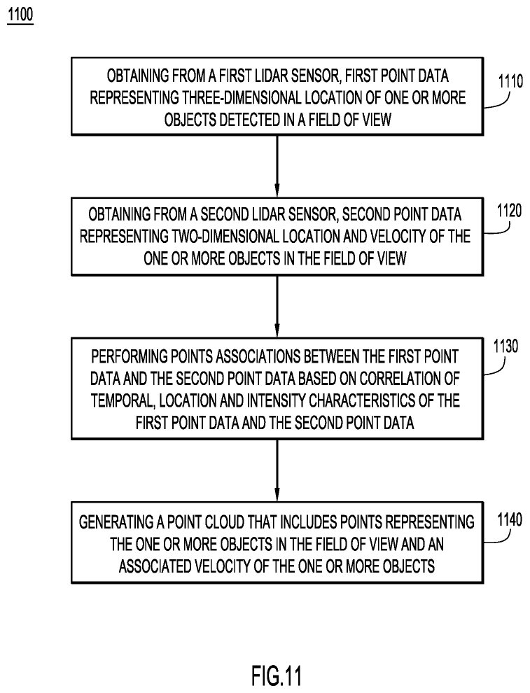

Once points associations are made, a point cloud is created for a time T1 that includes three-dimensional points and associated velocities, e.g., annotated velocities, in a step 840. Upon creating a point cloud with annotated velocity information, the method of utilizing an overall sensor system that includes a ToF lidar sensor and a coherent or FMCW lidar sensor is completed. When associating velocity from points generated by the coherent or FMCW lidar sensor to points from the ToF lidar sensor, the velocity could be zero for points associated with detected objects that are stationary, whereas there may be points that have some velocity because they are moving objects and they will have some magnitude and direction for velocity (a velocity vector). An example is described below in connection with FIG. 10.

Reference is now made to FIG. 9. FIG. 9 shows the sensor pod 230 that contains/houses the ToF lidar sensor 410 and coherent or FMCW lidar sensor 420, and a top down view of the FOV 720 as seen by the ToF lidar sensor 410 and the coherent or FMCW lidar sensor 420. Thus, distance away from the sensor pod 230 is in the x-direction, and corresponds to range from the autonomous vehicle and the position of objects in the y-direction corresponds to the azimuth view of the sensor pod 230.

Points 900-1, 900-2, 900-3, 900-4 and 900-5 represent examples of three-dimensional positions of objects detected by the ToF lidar sensor 410. It should be understood that the points 900-1, 900-2, 900-3, 900-4 and 900-5 are merely a simplified example of points detected by the ToF lidar sensor, and typically there would be many more points detected by the ToF lidar sensor in an actual deployment, depending on the surroundings of an autonomous vehicle. The ToF lidar sensor 410 provides three-dimensional position data associated with the points 900-1, 900-2, 900-3, 900-4 and 900-5, but does not provide velocity information for these points. As described in connection with FIG. 10 below, the data output by the ToF lidar sensor 410 for each detected object is a three-dimensional position together with an intensity value. The intensity value represents the intensity of reflected light from an objected detected by the ToF lidar sensor 410.

The coherent or FMCW lidar sensor 420 produces (lower resolution) two-dimensional location information of detected objects and velocity information of detected objects. For example, point 910 shows the two-dimensional position of an object detected by the coherent or FMCW lidar sensor 420. The data for point 910 may include a two-dimensional position as well as a velocity vector (magnitude and direction) of an object detected by the coherent or FMCW lidar sensor 420. The larger size of the circle representing the point 910 is meant to indicate that the precision probability of detection of the position of the object by the coherent or FMCW lidar sensor 420 is less than that of an object detected by the ToF lidar sensor 410. Nevertheless, the precision probability of detection of the position of the object corresponding to point 910 (using a coherent or FMCW lidar sensor) in the azimuth direction is substantially better than that of a radar sensor, which is a much larger area, shown at reference numeral 920. As a result, when, in step 830 described above in connection with FIG. 8, the points association operation is performed between data produced by the ToF lidar sensor 410 and the data produced by the coherent or FMCW lidar sensor 420, it is much easier to make the correct association between point 900-5 and point 910. By contrast, if a radar sensor were used instead of a coherent or FMCW lidar sensor, it is possible that the point association could be incorrectly made between point 910 and point 900-1. Thus, when using a coherent or FMCW lidar sensor 420 together with a ToF lidar sensor 410, the velocity information provided by the coherent or FMCW lidar sensor 420 can be more easily and accurately associated with the corresponding point in the point cloud produced by the ToF lidar sensor 410.

Reference is now made to FIG. 10. FIG. 10 shows points representing data for objects detected by the dual lidar sensor arrangement described above. In particular, the plot 1000 shows data representing a (simplified) point cloud detected by the ToF lidar sensor, where each point is associated with a detected object and includes coordinates (x,y,z) and reflectivity intensity (I). In this simplified example, the ToF lidar sensor detects three objects and the points 1010-1, 1010-2 and 1010-3 represent those three objects. Object 1, represented by point 1010-1, is described by (X1, Y1, Z1, I1), where I1 is the reflectivity intensity of object 1. Object 2, represented by point 1010-2, is described by (X2, Y2, Z2, I2), where I2 is the reflectivity intensity of object 2, and similarly, object 3, represented by point 1010-3, is described by (X3, Y3, Z3, I3), where I3 is the reflectivity intensity of object 3. The ToF lidar sensor does not provide velocity information of the detected objects.

The coherent or FMCW lidar sensor produces lower resolution range information but provides velocity information. Plot 1020 shows data representing a plot of objects detected by the coherent or FMCW lidar sensor at the same instant of time as the data shown in plot 1000. Object 1, represented by point 1030-1, is described by two-dimensional location information, intensity information and velocity information, e.g., (X1, Y1, I1, V1), where V1 is a vector for the velocity (e.g., radial velocity with respect to the coherent or FMCW lidar sensor in the x-y plane) of object 1. Thus, the velocity V1 has a direction component and a magnitude component. Object 2, represented by point 1030-2, is described by (X2, Y2, I2, V2), where V2 is a vector for the velocity (e.g., radial velocity in the x-y plane) of object 2, and similarly, object 3, represented by point 1010-3, is described by (X3, Y3, I3, V3), where V3 is a vector for the velocity (e.g., radial velocity in the x-y plane) of object 3. Again, the coherent or FMCW lidar sensor provides two-dimensional location information (lower resolution location information than that of the ToF sensor), intensity information and velocity information.

An annotated point cloud is shown in the plot 1040 in FIG. 10. This plot 1040 represents the outcome of step 840 of method 800 of FIG. 8, for the example data shown in plots 1000 and 1020 in FIG. 10. The annotated point cloud is created by appending the velocity information obtained for points detected by the coherent or FMCW lidar sensor to the appropriately associated points in the 3D point cloud created by the ToF lidar sensor. In this example, the points 1030-1, 1030-2 and 1030-3 (with velocity information) detected by the coherent or FMCW lidar sensor are associated to points 1010-1, 1010-2 and 1010-3, respectively, detected by the ToF sensor. Thus, the plot 1040 shows points 1050-1, 1050-2 and 1050-3, which correspond in position and intensity to points 1010-1, 1010-2, and 1010-3, respectively, and now include velocity information V1, V2, and V3, respectively.

Reference is now made to FIG. 11 that shows a flow chart depicting a method 1100 according to an example embodiment. At step 1110, the method 1100 includes obtaining from a first lidar sensor, first point data representing a three-dimensional location of each of one or more objects detected in a field of view. At step 1120, the method 1100 includes obtaining from a second lidar sensor, second point data representing a two-dimensional location and velocity of each of the one or more objects in the field of view. Steps 1110 and 1120 may be performed substantially simultaneously insofar as the first lidar sensor and the second lidar have the same field of view but otherwise operate independently. At 1130, the method 1100 includes performing points associations between the first point data and the second point data based on correlation of temporal, location (spatial) and intensity characteristics of the first point data and the second point data. At step 1140, based on the points associations between the first point data and the second point data in step 1130, the method 1100 includes generating a point cloud that includes points representing the one or more objects in the field of view and an associated velocity of the one or more objects.

In one form, the method 1100 further includes performing timing and scanning synchronization, for a given time instant, on the first point data and the second point data to determine that the first point data and the second point data were captured at the given time instant.

The step 1130 of performing points association may further comprise: matching points representing the one or more objects in the second point data based on similarity in time, location and intensity to points representing the one or more objects in the first point data; and based on the matching, assigning velocity information for points in the second point data to corresponding points in the first point data.

As described above, the first point data represents locations of objects with a higher resolution than that of the second point data.

Moreover, the first lidar sensor may be a Time-of-Flight (ToF) lidar sensor and the second lidar sensor may be a coherent lidar sensor or frequency modulated continuous wave (FMCW) lidar sensor. Further, the second lidar sensor may be configured to generate a single divergent beam that is scanned substantially only in azimuth with respect to a direction of movement of a vehicle.

The step 1110 of obtaining the first point data from the first lidar sensor and the step 1120 of obtaining the second point data from the second lidar sensor are performed on a vehicle, and the field of view for the first lidar sensor and the second lidar sensor is arranged in a direction of movement of the vehicle, and wherein the second lidar sensor is configured to scan substantially only in azimuth with respect to the direction of movement of the vehicle.

Similarly, the step 1110 of obtaining the first point data from the first lidar sensor and the step 1120 of obtaining the second point data from the second lidar sensor are performed on an autonomous vehicle. The method 1100 may further comprise controlling movement of the autonomous vehicle based, at least in part, on location and velocity of the one or more objects in the field of view.

To summarize, a system and techniques are provided here whereby a first lidar sensor provides a three-dimensional (higher resolution) location of objects, and a second lidar sensor provides two-dimensional location information (lower resolution) and velocity information of detected objects. The point cloud generated by the first lidar sensor is annotated with the velocity information obtained the second lidar sensor. In other words, the outputs from the two lidar sensors are combined to annotate the higher resolution data from the first lidar sensor with velocity information of detected objects. The first lidar sensor may be a ToF lidar sensor and the second lidar sensor may be a two-dimensional coherent or FMCW lidar sensor.

The combination of a ToF lidar sensor that provides three-dimensional location information (without velocity information) and a two-dimensional coherent or FMCW lidar sensor that generates two-dimensional location information and velocity information, provides for a lower cost and less complex lidar sensor solution than a single three-dimensional lidar sensor that provides velocity information.

Although only a few embodiments have been described in this disclosure, it should be understood that the disclosure may be embodied in many other specific forms without departing from the spirit or the scope of the present disclosure. By way of example, a sensor system that may effectively generate a point cloud with annotated velocities may include any suitable lidar systems. In other words, lidar sensors other than a ToF lidar sensor and a two-dimensional coherent or FMCW lidar sensor may be used to generate a point cloud with annotated velocities. Generally, one lidar sensor may be used to obtain relatively accurate points relating to objects, and another lidar sensor may be used to obtain velocities relating to the objects.

A two-dimensional coherent or FMCW lidar sensor may be capable of detecting moving obstacles that are between approximately 80 meters (m) and approximately 300 m away from the lidar sensor. In some instances, the lidar sensor may be arranged to detect moving obstacles that are between approximately 120 m and approximately 200 m away from the sensor. The lidar sensor may use a single divergent, or fan-shaped, beam that is scanned substantially only in azimuth and not in elevation, as previously mentioned. When an autonomous vehicle is at a distance of between approximately 120 m and approximately 200 m away from an object, the autonomous vehicle is generally concerned with moving objects, and not as concerned with substantially stationary objects. As such, any potential inability to distinguish between objects at different elevations using a single divergent beam scanned substantially only in azimuth is not critical, particularly as a ToF lidar sensor and/or other sensors may be used to distinguish between objects at different elevations as the autonomous vehicle nears the objects. Thus, a two-dimensional coherent or FMCW lidar sensor, and in particular any two-dimensional lidar sensor that scans substantially only in the azimuth, can work well for autonomous vehicle applications in which there is no need to scan in the elevation (vertical) direction, such as when there is interest in objects mostly out beyond approximately 100 meters.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure. In general, an autonomous vehicle may be any suitable transport apparatus that may operate in an unmanned, driverless, self-driving, self-directed, and/or computer-controlled manner.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. For example, the systems of an autonomous vehicle, as described above with respect to FIG. 3, may include hardware, firmware, and/or software embodied on a tangible medium. A tangible medium may be substantially any computer-readable medium that is capable of storing logic or computer program code that may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

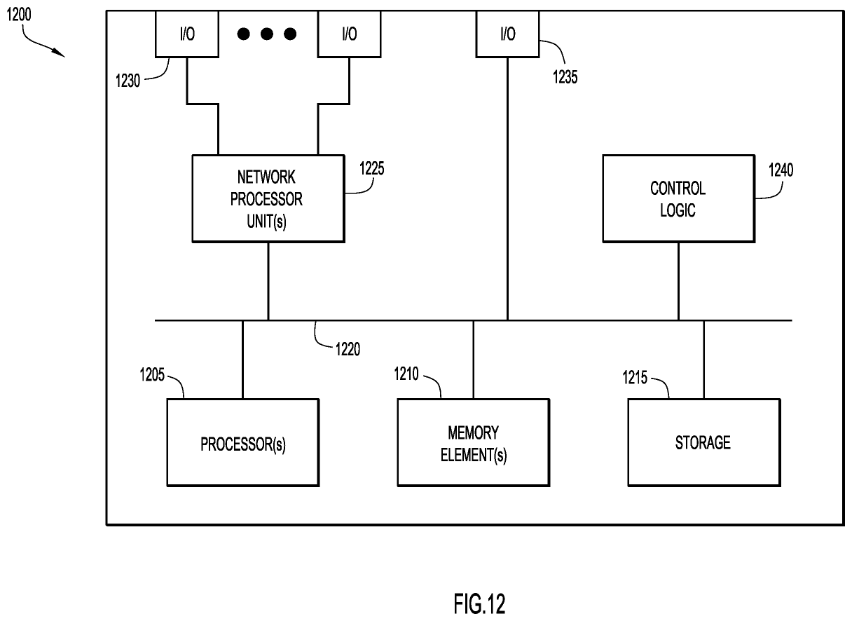

Referring now to FIG. 12, FIG. 12 illustrates a hardware block diagram of a computing device 1200 that may perform functions associated with operations discussed herein in connection with the techniques depicted in FIGS. 1-11. In various example embodiments, a computing device, such as computing device 1200 or any combination of computing devices 1200, may be configured as any entity/entities as discussed for the techniques depicted in connection with FIGS. 1-11 in order to perform operations of the various techniques discussed herein.

In at least one embodiment, computing device 1200 may include one or more processor(s) 1205, one or more memory element(s) 1210, storage 1215, a bus 1220, one or more network processor unit(s) 1225 interconnected with one or more network input/output (I/O) interface(s) 1230, one or more I/O interface(s) 1235, and control logic 1240. In various embodiments, instructions associated with logic for computing device 1200 can overlap in any manner and are not limited to the specific allocation of instructions and/or operations described herein.

In at least one embodiment, processor(s) 1205 is/are at least one hardware processor configured to execute various tasks, operations and/or functions for computing device 1200 as described herein according to software and/or instructions configured for computing device. Processor(s) 1205 (e.g., a hardware processor) can execute any type of instructions associated with data to achieve the operations detailed herein. In one example, processor(s) 1205 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term “processor.”

In at least one embodiment, memory element(s) 1210 and/or storage 1215 is/are configured to store data, information, software, and/or instructions associated with computing device 1200, and/or logic configured for memory element(s) 1210 and/or storage 1215. For example, any logic described herein (e.g., control logic 1240) can, in various embodiments, be stored for computing device 1200 using any combination of memory element(s) 1210 and/or storage 1215. Note that in some embodiments, storage 1215 can be consolidated with memory element(s) 1210 (or vice versa), or can overlap/exist in any other suitable manner.

In at least one embodiment, bus 1220 can be configured as an interface that enables one or more elements of computing device 1200 to communicate in order to exchange information and/or data. Bus 1220 can be implemented with any architecture designed for passing control, data and/or information between processors, memory elements/storage, peripheral devices, and/or any other hardware and/or software components that may be configured for computing device 1200. In at least one embodiment, bus 1220 may be implemented as a fast kernel-hosted interconnect, potentially using shared memory between processes (e.g., logic), which can enable efficient communication paths between the processes.

In various embodiments, network processor unit(s) 1225 may enable communication between computing device 1200 and other systems, entities, etc., via network I/O interface(s) 1230 to facilitate operations discussed for various embodiments described herein. In various embodiments, network processor unit(s) 1225 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 1200 and other systems, entities, etc. to facilitate operations for various embodiments described herein. In various embodiments, network I/O interface(s) 1230 can be configured as one or more Ethernet port(s), Fibre Channel ports, and/or any other I/O port(s) now known or hereafter developed. Thus, the network processor unit(s) 1225 and/or network I/O interfaces 1230 may include suitable interfaces for receiving, transmitting, and/or otherwise communicating data and/or information in a network environment.

I/O interface(s) 1235 allow for input and output of data and/or information with other entities that may be connected to computer device 1200. For example, I/O interface(s) 1235 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 1240 can include instructions that, when executed, cause processor(s) 1205 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1240) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term “memory element.” Data/information being tracked and/or sent to one or more entities as discussed herein could be provided in any database, table, register, list, cache, storage, and/or storage structure: all of which can be referenced at any suitable timeframe. Any such storage options may also be included within the broad term “memory element” as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software (potentially inclusive of object code and source code), etc.) for execution by one or more processor(s), and/or other similar machine, etc. Generally, memory element(s) 1210 and/or storage 1215 can store data, software, code, instructions (e.g., processor instructions), logic, parameters, combinations thereof, and/or the like used for operations described herein. This includes memory element(s) 1210 and/or storage 1215 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fib®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’(s)′ nomenclature (e.g., one or more element(s)).

In summary, in one form, computer-implemented method is provided that comprises: obtaining from a first lidar sensor, first point data representing a three-dimensional location of one or more objects detected in a field of view; obtaining from a second lidar sensor, second point data representing a two-dimensional location and velocity of the one or more objects in the field of view; performing points associations between the first point data and the second point data based on correlation of temporal, location and intensity characteristics of the first point data and the second point data; and based on the points associations between the first point data and the second point data, generating a point cloud that includes points representing the one or more objects in the field of view and an associated velocity of the one or more objects.

In another form, a sensor system is provided comprising: a first lidar sensor configured to generate first point data representing a three-dimensional location of one or more objects detected in a field of view; a second lidar sensor configured to generate second point data representing a two-dimensional location and velocity of the one or more objects in the field of view; one or more processors coupled to the first lidar sensor and the second lidar sensor, wherein the one or more processors are configured to: perform points associations between the first point data and the second point data based on correlation of temporal, location and intensity characteristics of the first point data and the second point data; and based on the points associations between the first point data and the second point data, generate a point cloud that includes points representing the one or more objects in the field of view and an associated velocity of the one or more objects.

In still another form, one or more non-transitory computer readable storage media are provided comprising instructions that, when executed by at least one processor, are operable to perform operations including: obtaining from a first lidar sensor, first point data representing a three-dimensional location of one or more objects detected in a field of view; obtaining from a second lidar sensor, second point data representing a two-dimensional location and velocity of the one or more objects in the field of view; performing points associations between the first point data and the second point data based on correlation of temporal, location and intensity characteristics of the first point data and the second point data; and based on the points associations between the first point data and the second point data, generating a point cloud that includes points representing the one or more objects in the field of view and an associated velocity of the one or more objects.

[olio] One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A computer-implemented method comprising:
obtaining from a first lidar sensor, first point data representing a three-dimensional location of one or more objects detected in a field of view;
obtaining from a second lidar sensor, second point data representing a two-dimensional location and velocity of the one or more objects in the field of view;
performing points associations between the first point data and the second point data based on correlation of temporal, location and intensity characteristics of the first point data and the second point data; and
based on the points associations between the first point data and the second point data, generating a point cloud that includes points representing the one or more objects in the field of view and an associated velocity of the one or more objects.

2. The method of claim 1, further comprising performing timing and scanning synchronization, for a given time instant, on the first point data and the second point data to determine that the first point data and the second point data were captured at the given time instant.

3. The method of claim 1, wherein performing points associations comprises:
matching points representing the one or more objects in the second point data based on similarity in time, location and intensity to points representing the one or more objects in the first point data; and
based on the matching, assigning velocity information for points in the second point data to corresponding points in the first point data.

4. The method of claim 1, wherein the first point data represents locations of objects with a higher resolution than that of the second point data.

5. The method of claim 1, wherein the first lidar sensor is a Time-of-Flight (ToF) lidar sensor.

6. The method of claim 1, wherein the second lidar sensor is a coherent lidar sensor or frequency modulated continuous wave (FMCW) lidar sensor.

7. The method of claim 6, wherein the second lidar sensor is configured to generate a single divergent beam that is scanned substantially only in azimuth with respect to a direction of movement of a vehicle.

8. The method of claim 1, wherein the obtaining the first point data from the first lidar sensor and obtaining the second point data from the second lidar sensor are performed on a vehicle, and wherein the field of view for the first lidar sensor and the second lidar sensor is arranged in a direction of movement of the vehicle, and wherein the second lidar sensor is configured to scan substantially only in azimuth with respect to the direction of movement of the vehicle.

9. The method of claim 1, wherein the obtaining from the first point data from the first lidar sensor and obtaining the second point data from the second lidar sensor are performed on an autonomous vehicle.

10. The method of claim 9, further comprising:
controlling movement of the autonomous vehicle based, at least in part, on location and velocity of the one or more objects in the field of view.

11. A sensor system comprising:
a first lidar sensor configured to generate first point data representing a three-dimensional location of one or more objects detected in a field of view;
a second lidar sensor configured to generate second point data representing a two-dimensional location and velocity of the one or more objects in the field of view;
one or more processors coupled to the first lidar sensor and the second lidar sensor, wherein the one or more processors are configured to:
perform points associations between the first point data and the second point data based on correlation of temporal, location and intensity characteristics of the first point data and the second point data; and
based on the points associations between the first point data and the second point data, generate a point cloud that includes points representing the one or more objects in the field of view and an associated velocity of the one or more objects.

12. The sensor system of claim 11, wherein the one or more processors are configured to:
perform timing and scanning synchronization, for a given time instant, on the first point data and the second point data to determine that the first point data and the second point data were captured at the given time instant.

13. The sensor system of claim 11, wherein the one or more processors are configured to perform the points associations by:
matching points representing the one or more objects in the second point data based on similarity in time, location and intensity to points representing the one or more objects in the first point data; and
based on the matching, assigning velocity information for points in the second point data to corresponding points in the first point data.

14. The sensor system of claim 11, wherein the first lidar sensor is a Time-of-Flight (ToF) lidar sensor and the second lidar sensor is a coherent lidar sensor or frequency modulated continuous wave (FMCW) lidar sensor.

15. The sensor system of claim 14, wherein the second lidar sensor is configured to generate a single divergent beam that is scanned substantially only in azimuth with respect to a direction of movement of a vehicle.

16. The sensor system of claim 11, wherein the first lidar sensor and the second lidar sensor are configured to be mounted on a vehicle, and wherein the field of view for the first lidar sensor and the second lidar sensor is arranged in a direction of movement of the vehicle, and wherein the second lidar sensor is configured to scan substantially only in azimuth with respect to the direction of movement of the vehicle.

17. One or more non-transitory computer readable storage media comprising instructions that, when executed by at least one processor, are operable to perform operations including:
obtaining from a first lidar sensor, first point data representing a three-dimensional location of one or more objects detected in a field of view;
obtaining from a second lidar sensor, second point data representing a two-dimensional location and velocity of the one or more objects in the field of view;
performing points associations between the first point data and the second point data based on correlation of temporal, location and intensity characteristics of the first point data and the second point data; and
based on the points associations between the first point data and the second point data, generating a point cloud that includes points representing the one or more objects in the field of view and an associated velocity of the one or more objects.

18. The one or more non-transitory computer readable storage media of claim 17, further comprising instructions that, when executed by the at least one processor, cause the at least one processor to perform timing and scanning synchronization, for a given time instant, on the first point data and the second point data to determine that the first point data and the second point data were captured at the given time instant.

19. The one or more non-transitory computer readable storage media of claim 17, further comprising instructions that, when executed by the at least one processor, cause the at least one processor to perform points associations by:
matching points representing the one or more objects in the second point data based on similarity in time, location and intensity to points representing the one or more objects in the first point data; and
based on the matching, assigning velocity information for points in the second point data to corresponding points in the first point data.

20. The one or more non-transitory computer readable storage media of claim 17, wherein the first point data represents locations of objects with a higher resolution than that of the second point data.

21. The one or more non-transitory computer readable storage media of claim 17, wherein the first lidar sensor is a Time-of-Flight (ToF) lidar sensor and the second lidar sensor is a coherent lidar sensor or frequency modulated continuous wave (FMCW) lidar sensor.

22. The one or more non-transitory computer readable storage media of claim 17, wherein the first lidar sensor and the second lidar sensor are mounted on an autonomous vehicle, and further comprising instructions that, when executed by the at least one processor, cause the at least one processor to control movement of the autonomous vehicle based, at least in part, on location and velocity of the one or more objects in the field of view of the first lidar sensor and the second lidar sensor.
